(19) United States
(12) Patent Application Publication
(10) Pub. No.: US 2017/0089423 A1
(43) Pub. Date: Mar. 30, 2017

(54) CRANKSHAFT AND METHOD OF BALANCING THE SAME

(71) Applicant: GM GLOBAL TECHNOLOGY OPERATIONS LLC, Detroit, MI (US)

(72) Inventors: Scott A. Hucker, Ortonville, MI (US); Dale Edward Murrish, Troy, MI (US)

(73) Assignee: GM GLOBAL TECHNOLOGY OPERATIONS LLC, Detroit, MI (US)

(21) Appl. No.: 14/870,933

(22) Filed: Sep. 30, 2015

(51) Int. Cl. F16F 15/28; F16C 3/06

(52) U.S. Cl. CPC F16F 15/283; F16C 3/06

(57) ABSTRACT

A crankshaft includes a plurality of counterweights. Each of the counterweights includes a counterweight body. The counterweight body has a first lateral portion, a second lateral portion, and a central portion between the first lateral portion and the second lateral portion. A method of balancing the crankshaft includes: (a) removing material from the first lateral portion of the counterweight body of at least one of the counterweights; and (b) removing material from the second lateral portion of the counterweight body of at least one of the counterweights in order to balance the crankshaft.

### TECHNICAL FIELD

The present disclosure relates to a crankshaft and a method of balancing a crankshaft.

### BACKGROUND

Internal combustion engines include at least one crankshaft. A crankshaft converts reciprocating linear movement of a piston into rotational movement about a crankshaft axis to provide torque to propel a vehicle, such as but not limited to a train, a boat, a plane, or an automobile, or to drive any other apparatus powered by the engine.

The crankshaft includes at least one crankpin that is offset from the crankshaft axis, to which a reciprocating piston is attached via a connecting rod. Force applied from the piston to the crankshaft through the offset connection therebetween generates torque in the crankshaft, which rotates the crankshaft about the crankshaft axis. The crankshaft further includes at least one main bearing journal disposed concentrically about the crankshaft axis. The crankshaft is secured to an engine block at the main bearing journals. A bearing is disposed about the main bearing journal, between the crankshaft and the engine block.

### SUMMARY

Crankshafts are a vital part of an engine, and are a starting point of engine design. Crankshaft design affects the overall packaging of the engine, and thereby the total mass of the engine. Accordingly, minimizing the size and/or mass of the crankshaft reduces the size and mass of the engine, which has a compounding effect on the overall size, mass and fuel economy of the vehicle. It is also desirable to design the crankshaft by minimizing its mass and rotating inertia in order to maximize vehicle fuel economy. To this end, the present disclosure describes a method of balancing a crankshaft that results in minimizing the mass and rotating inertia of the crankshaft. The crankshaft includes a plurality of counterweights. Each of the counterweights includes a counterweight body, which has a first lateral portion, a second lateral portion, and a central portion between the first lateral portion and the second lateral portion.

In an embodiment, the method of balancing the crankshaft includes: (a) removing material from the first lateral portion of the counterweight body of at least one of the counterweights; and (b) removing material from the second lateral portion of the counterweight body of at least one of the counterweights in order to balance the crankshaft. The present disclosure also describes crankshafts that are balanced using the method described above.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic, perspective view of a crankshaft in accordance with an embodiment of the present disclosure;

FIG. 2 is a schematic, side view of the crankshaft shown in FIG. 1;

FIG. 3 is a schematic, front view of the crankshaft shown in FIG. 1 before the lateral portions of the counterweight are removed;

FIG. 4 is a schematic, front view of the crankshaft shown in FIG. 1 after material has been removed from opposite sides of the counterweight; and

FIG. 5 is a flowchart of a method for balancing the crankshaft.

### DETAILED DESCRIPTION

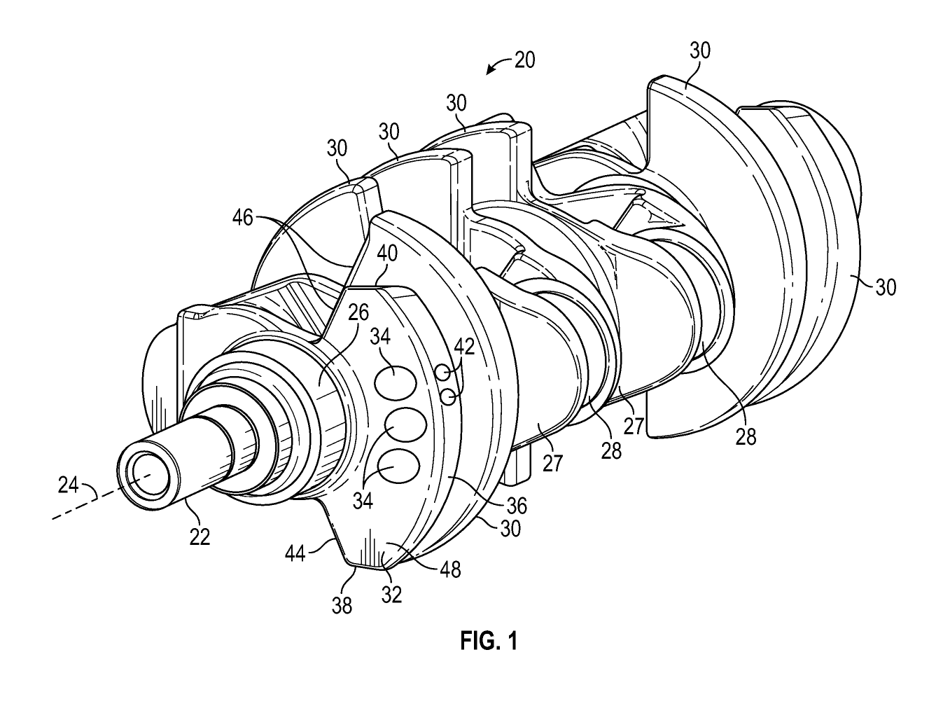

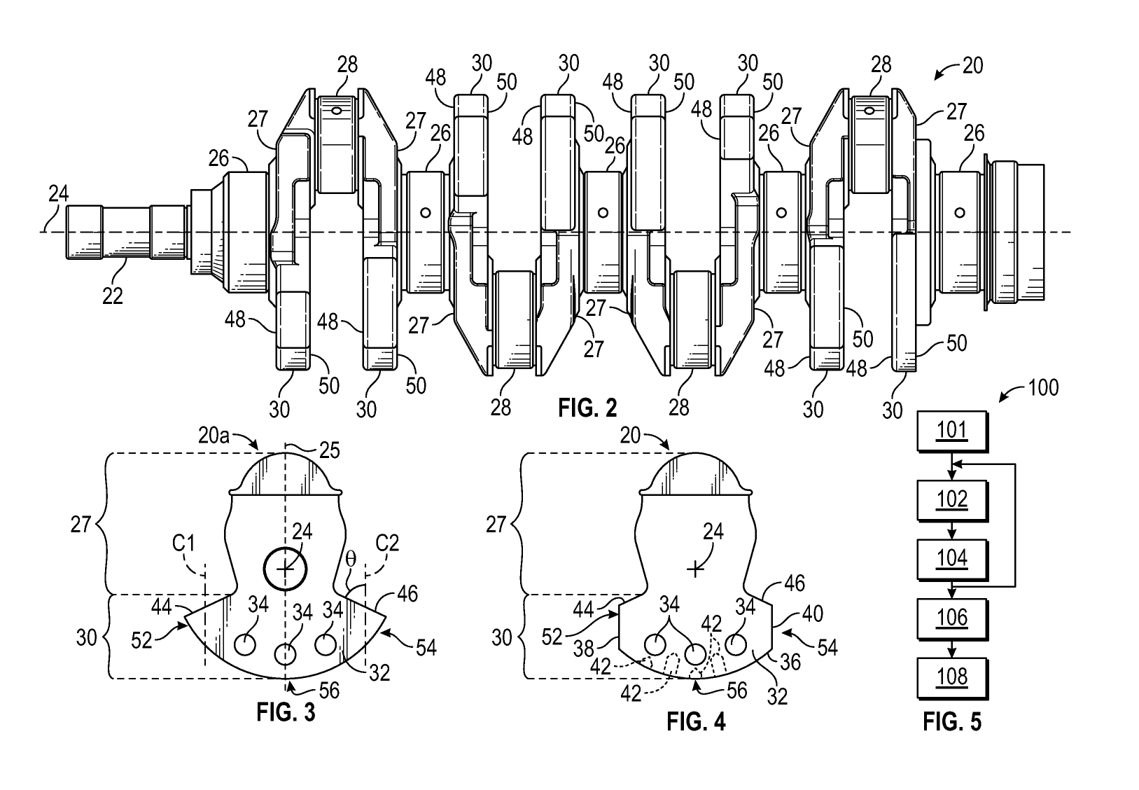

Referring to the FIGS. 1 and 2, wherein like numerals indicate like parts throughout the several views, a crankshaft is generally shown at 20. The crankshaft 20 may be configured for an engine, such as but not limited to a gasoline engine or a diesel engine, a compressor, or some other similar device. The crankshaft 20 includes a shaft 22 extending along a crankshaft axis 24. The shaft 22 defines a plurality of main bearing journals 26, a plurality of arms 27, a plurality of pin bearing journals 28, and a plurality of counterweights 30. The pin bearing journals 28 are also referred to as crankpins.

The main bearing journals 26 are disposed concentrically about the crankshaft axis 24. Therefore, all the main bearing journals 26 are aligned with one another along the crankshaft axis 24. Each main bearing journal 26 is coupled to at least one of the arms 27. The crankshaft 20 may be configured for engines with different crank configurations, such as two crankpins between main bearing journals, shared pin engines (V8), and single cylinder engines.

Each of the pin bearing journals 28 is laterally offset from the crankshaft axis 24, and is attached to the main bearing journals 26 by one of the arms 27. Thus, each pin bearing journal 28 interconnects two arms 27. Each of the arms 27 extends from one of the main bearing journals 26 to one of the pin bearing journals 28. At least some of the arms 27 are coupled to a counterweight 30. Each of the counterweights 30 extends radially away from the crankshaft axis 24. Each of the main bearing journals 26 supports a bearing (not shown) thereabout, and provides an attachment location for attaching the crankshaft 20 to an engine block (not shown). Each of the pin bearing journals 28 supports a bearing (not shown) thereabout, and provides the attachment point to which a connecting rod (not shown) attaches a piston (not shown) to the crankshaft 20. Moreover, each pin bearing journal 28 interconnects two arms 27.

The counterweights 30 offset the reciprocating mass of the pistons, piston rings, piston pins and retaining clips, the small ends of the connecting rods, the rotating mass of the connecting rod large ends and bearings, and the rotating mass of the crankshaft itself (the pin bearing journals 28 and the arms 27). The main bearing journals 26 are on the crankshaft axis 24 and do not require any counterweights. The counterweights 30 reduce the forces acting on the main bearing journals and thereby improve the durability of the bearings. The counterweights 30 balance the rotation of the crankshaft 20 about the crankshaft axis 24 to reduce vibration therein.

At least one of the counterweights 30 includes a counterweight body 32 wholly or partly made of a substantially rigid material, such as steel. In addition, the counterweight 30 includes at least one slug 34 at least partially disposed inside the counterweight body 32 in order to reduce loads on the crankshaft main bearings 26 or balance internal forces and moments of the crankshaft 20. Although the depicted embodiment shows three slugs 34, it is contemplated that the counterweight 30 may include more or fewer slugs 34 depending on the design specification of the crankshaft 20. In this context, the “design specification” refers to how much counterweighting force is needed at that particular counterweight. The slugs 34 are wholly or partly made of a substantially rigid material, such as tungsten, that has a higher density than the material forming the counterweight body 32 in order to provide the proper amount of counterweighting for the crankshaft 20.

Referring to FIGS. 1, 2 and 4, crankshaft design affects the overall packaging of the engine, and thereby the total mass of the engine. Accordingly, minimizing the size and/or mass of the crankshaft reduces the size and mass of the engine, which has a compounding effect on the overall size, mass and fuel economy of the vehicle. To this end, the presently disclosed crankshaft 20 can be balanced by removing material from opposite sides of at least one of the counterweights 30. As a result, the counterweight body 32 of the balanced crankshaft 20 includes a truncated curved wall 36 extending from a first sidewall 38 to a second sidewall 40 of the counterweight body 32. In the embodiment shown in FIGS. 1, 3 and 4, the entire curved wall 36 has a constant radius of curvature in order to minimize the rotating inertia of the crankshaft 20. It should be appreciated, however, that for other engine designs the total mass of the crankshaft 20 is more important, so a dual radius or other method may be employed to minimize clearance from the piston to the counterweight (effectively a larger radius from crank centerline) as the crankshaft 20 and piston rotate from bottom dead center, and thereby a lighter counterweight. The first sidewall 38 and the second sidewall 40 of the counterweight body 32 are on opposite sides of the counterweight 30 and may be planar walls in order to minimize the mass and the rotating inertia of the crankshaft 20. In other words, the first sidewall 38 and the second sidewall 40 may each have a planar shape. For example, the first sidewall 38 and the second sidewall 40 may be orthogonal to the crankshaft axis 24 in order to minimize the rotating inertia of the crankshaft 20. It is also envisioned that the first sidewall 38 and/or the second sidewall 40 may have a non-linear profile in order to minimize turbulence, windage, and air entertainment, thereby maximizing the fuel economy of the engine. The first sidewall 38 and the second sidewall 40 can be formed by removing material from opposite sides of the counterweight body 32. For instance, the counterweight body 32 may be milled in order to form the first sidewall 38 and the second sidewall 40. Moreover, a piece of material, such as metal, may be added to the counterweight body 32 in order to meet specific balance requirements (e.g., zero bias in the counterweight 30). Bias is extra mass added to counterweights to ensure there is always material to remove from the counterweights for balancing the crankshaft. The amount of bias depends on the engine configuration and size of the crankshaft. Welding may be used to add the piece of material to the counterweight body 32.

At least one hole 42 may extend into the curved wall 36 in order to balance the crankshaft 20. In the depicted embodiment, the holes 42 extend into the curved wall 36 and toward the slugs 34 and are intended for a second balance pass to reach the final balance specification. However, the slugs 34, which help counterweight the crankshaft 20, are unaffected by the holes 42, because none of the holes 42 extends into or through the slugs 34. It is undesirable to drill into the tungsten alloy slugs 34 because of their hardness, affecting tool life. Accordingly, by removing material from opposite sides of the counterweight body 32 in order to form the first sidewall 38 and the second sidewall 40, more slugs 34 can be incorporated into the counterweight body 32, thereby allowing the crankshaft 20 to be counterweighted more mass efficiently with the addition of heavy metal slugs 34 in the desired direction, in this case opposite the crankpin for a four cylinder crankshaft. As discussed below, the optional holes 42 can be formed by drilling the counterweight body 32. Alternatively, the milling operation may be repeated as a second pass balancing operation.

The counterweight body 32 also includes a first connecting wall 44 directly connected to the arm 27 and a second connecting wall 46 directly connected to the arm 27. In the balanced crankshaft 20, the first connecting wall 44 is also directly coupled to the first sidewall 38, and the second connecting wall 46 is directly coupled to the second sidewall 40. The first connecting wall 44 and the second connecting wall 46 are closer to the arm 27 than the curved wall 36. The slugs 34 are closer to the curved wall 36 than to the first connecting wall 44 and the second connection wall 46 in order to effectively counterweight the crankshaft 20. They are also closer to the centerline opposite the crankpin 28 for more mass efficiency. If milling the counterweights is used for the second pass balancing operation, the slugs 34 can be located closer to the curved wall 36 for greater mass efficiency.

Each counterweight body 32 also includes a first or front axial wall 48 and a second or rear axial wall 50 opposite the first axial wall 48. The first sidewall 38, the second sidewall 40, the first connecting wall 44, the second connecting wall 46, and the curved wall 36 are all entirely disposed between the first axial wall 48 and the second axial wall 50.

Each counterweight body 32 includes a first lateral portion 52, a second lateral portion 54 opposite the first lateral portion 52, and a central portion 56 between the first lateral portion 52 and the second lateral portion 54. The first lateral portion 52 includes the first sidewall 38, at least portions of the first connecting wall 44, and portions of the curved wall 36. The second lateral portion 54 includes the second sidewall 40, at least portions of the second connecting wall 46, and portions of the curved wall 36. The central portion 56 of the counterweight body 32 includes at least some portions of the curved wall 36. All the slugs 34 are embedded inside the central portion 56 of the counterweight body 32 near the vertical axis 25 opposite the crankpin 28 to maximize the counterweight force and minimize the crankshaft mass. It is contemplated that the crankshaft 20 may not include slugs 34, depending on design requirements.

With reference to FIGS. 3-5, the present disclosure describes a method 100 for manufacturing and balancing a crankshaft 20a in accordance with predetermined balancing requirements. It is useful to balance the crankshaft 20a in order to reduce engine vibration inherent to each engine type, accounting for the mass of the crankshaft, connecting rods, pistons, pins etc. to balance it. As discussed below, in the method 100, work is performed on at least one counterweight 30 in order to balance the crankshaft 20a according to predetermined balancing specifications. At step 101, the unbalanced crankshaft 20a (FIG. 3) can be made using casting, forging, or any other suitable manufacturing method. Once the unbalanced crankshaft 20a is formed, the method 100 proceeds to step 102.

Step 102 entails determining the amount of material in the counterweight body 32 that needs to be removed in order to achieve predetermined balance requirements. In doing so, the unbalanced crankshaft 20a is rotated about the crankshaft axis 24. While the crankshaft 20a is rotating, conventional, known methods are used to determine the amount and location of counterweight material that needs to be removed in order to balance the crankshaft 20a. Also in step 102, material (e.g., metal) from the first lateral portion 52 of the counterweight body 32 is removed. This material can be removed by milling the counterweight body 32 along the first cut line C1, which can be vertical (parallel to an axis 25 between the crankpin 28 and the main bearing 26) or angled slightly depending on whether the overall mass or rotating inertia of the counterweights is more important. For example, the first cut line C1 and/or the second cut line C2 may be oriented at an oblique angle θ (e.g., ±30 degrees) from the line 25. However, other machining methods can be used to remove material from the first lateral portion 52 of the counterweight body 32. Furthermore, the profile of the machined surface that forms the first sidewall 38 and the second sidewall 40 does not have to be flat (i.e., straight). A contoured profile, for example, can be desirable in order to minimize turbulence and air entrainment, thereby maximizing vehicle fuel economy. Next, the method 100 proceeds to step 104.

In step 104, material (e.g., metal) from the second lateral portion 54 of the counterweight body 32 is removed. This material can be removed by milling the counterweight body 32 along the second cut line C2. However, other machining methods can be used to remove material from the second lateral portion 54 of the counterweight body 32. Steps 102 and 104 can be performed in a different chronological order or simultaneously. Different amounts of material (e.g., metal) can be removed from each side (i.e., the first lateral side 52 and the second lateral side 54) to target and shift the crankshaft balance. This would be performed at any number of counterweights 30 as needed to meet the predetermined balance specification. Usually both front and rear of the crankshaft have a bias, which depends on the engine type and size of the crankshaft.

By first removing material from the first lateral portion 52 and the second lateral portion 54 of the counterweight body 32 (instead of first forming holes in the curved wall 36), more mass is removed and the rotating inertia is minimized even more in comparison with the method in which holes are first drilled in the curved wall 36, while correcting the same amount of crankshaft imbalance. In other words, by removing material from the first lateral portion 52 and the second lateral portion 54 of the counterweight body 32 first, more mass is removed to eliminate the crankshaft bias than by using conventional radial drills; therefore, the presently described balancing method 100 results in a lighter, lower inertia crankshaft 20 when compared to a crankshaft balanced using the conventional radial drilling method. After performing steps 102 and 104, the method 100 proceeds to step 106.

In step 106, the crankshaft 20 is rotated about the crankshaft axis 24. And while the crankshaft 20 is rotating, conventional, known methods are used to determine if additional counterweight material needs to be removed in order to achieve the predetermined crankshaft balance specification. If so, holes 42 can be formed between the curved wall 36 and the slugs 34 in order to remove additional material from the counterweight body 32. The counterweight body 32 can be drilled in order to form the holes 42. However, other machining methods can be used to form the holes 42. The holes 42 extend into the curved wall 36 toward the slugs 34. However, the holes do not extend into or through the slugs 34. As such, the slugs 34 are unaffected by the holes 42 and can continue to function to help counterweight the crankshaft 20. The holes 42 are formed in the central portion 56 of the counterweight body 32 in order to eliminate the crankshaft bias. Step 106 is optional. Alternatively, steps 102 and 104 can be repeated as many times as necessary to meet the balance specification. After forming the optional holes 42, the method 100 proceeds to step 108.

In step 108, material, such as metal, is added to the first lateral side 52 and/or the second lateral side 54 of the counterweight body 32. This method is used if a low or zero bias crankshaft is desired, which gives the lowest mass and inertia crankshaft. Accordingly, step 108 is optional. The material (i.e., metal) can be added to the counterweight body 32 using welding, fastening, or any other suitable joining method. For example, a piece of metal can be welded to the first lateral side 52 and/or the second lateral side 54 of the counterweight body 32 after steps 102, 104, and/or 106. Alternatively, a fastener, such as a bolt, can be used to attach a piece of metal to the first lateral side 52 and/or the second lateral side 54 of the counterweight body 32 after steps 102, 104, and/or 106.

While the best modes for carrying out the teachings have been described in detail, those familiar with the art to which this disclosure relates will recognize various alternative designs and embodiments for practicing the teachings within the scope of the appended claims.

1. A method of balancing a crankshaft, wherein the crankshaft includes a plurality of counterweights, each of the counterweights includes a counterweight body, the counterweight body has a first lateral portion, a second lateral portion, and a central portion between the first lateral portion and the second lateral portion, and the method comprises:
removing material from the first lateral portion of the counterweight body of at least one of the counterweights; and
removing material from the second lateral portion of the counterweight body of the at least one of the counterweights in order to balance the crankshaft.

2. The method of claim 1, wherein removing material from the first lateral portion of the counterweight body includes forming a first sidewall on the counterweight body, and the first sidewall has a planar shape.

3. The method of claim 2, wherein removing material from the second lateral portion of the counterweight body includes forming a second sidewall on the counterweight body, and the second sidewall has a planar shape.

4. The method of claim 1, further comprising forming at least one hole in the counterweight body.

5. The method of claim 4, wherein forming at least one hole includes drilling the at least one hole in the counterweight body.

6. The method of claim 4, wherein forming at least one hole includes forming the at least one hole in the central portion of the counterweight body.

7. The method of claim 4, wherein forming at least one hole is performed after removing material from the first lateral portion and the second lateral portion of the counterweight body.

8. The method of claim 4, wherein at least one of the counterweights includes a plurality of slugs partially disposed inside the counterweight body.

9. The method of claim 8, wherein forming at least one hole includes forming the at least one hole so that the at least one hole does not extend into the slugs.

10. The method of claim 9, wherein the at least one hole extends between two of the plurality of slugs.

11. The method of claim 1, further comprising adding material to the first lateral portion and the second lateral portion of the counterweight body.

12. The method of claim 11, wherein adding material to the first lateral portion and the second lateral portion of the counterweight body includes welding the material to the first lateral portion and the second lateral portion of the counterweight body after removing material from the first lateral portion and the second lateral portion of the counterweight body.

13. A crankshaft, comprising:
a plurality of main bearing journals aligned with one another along a crankshaft axis;
a plurality of arms, where each of the arms is coupled to one of the main bearing journals;
a plurality of pin bearing journals, wherein each of the pin bearing journals is coupled to at least one of the arms, and each of the arms is coupled between one of the main bearing journals and one of the pin bearing journals;
a plurality of counterweights, wherein each of the counterweights is coupled to one of the arms, and at least one of the counterweights includes:
a first sidewall;
a second sidewall opposite the first sidewall;
a curved wall extending from the first sidewall to the second sidewall; and
wherein each of the first and second sidewalls are created by removing material from the counterweights during a balancing process.

14. The crankshaft of claim 13, wherein the at least one of the plurality of counterweights includes the at least one of the sidewalls with a planar shape.

15. The crankshaft of claim 13, wherein the at least one of the counterweights includes a counterweight body and at least one slug disposed inside the counterweight body, the at least one slug is made of a first material, the counterweight body is made of a second material, and the first material has a higher density than the second material.

16. The crankshaft of claim 14, wherein the counterweight defines a plurality of holes extending into the curved wall.

17. The crankshaft of claim 16, wherein the holes extend into the curved wall and toward the slugs.

18. The crankshaft of claim 16, wherein the holes do not extend into the slugs.

19. The crankshaft of claim 17, wherein the at least one of the counterweights includes a first connecting wall and a second connecting wall, the first and second connecting walls are directly connected to one of the arms, the first connecting wall is directly connected to the first sidewall, the second connecting wall is directly connected to the second sidewall, and the at least one slug is closer to the curved wall than to the first and second connecting walls.

20. The crankshaft of claim 13, wherein the at least one of the counterweights includes a counterweight body and a plurality of slugs disposed inside the counterweight body, each of the slugs is made of a first material, the counterweight body is made of a second material, and the first material has a higher density than the second material, the counterweight defines at least one hole, and at least one of the holes extends between two of the slugs.
